(19) United States
(12) Patent Application Publication
(10) Pub. No.: US 2026/0235170 A1
(43) Pub. Date: Aug. 13, 2026

(54) CLUTCH SYSTEM FOR A BICYCLE TRANSMISSION

(71) Applicant: Classified Cycling BV, Antwerpen (BE)

(72) Inventor: Roëll Marie VAN DRUTEN, Eindhoven (NL)

(21) Appl. No.: 19/160,438

(22) PCT Filed: Feb. 27, 2024
(86) PCT No.: PCT/EP2024/054933

§ 371 Date: Aug. 27, 2025

(30) Foreign Application Priority Data
Feb. 27, 2023 (NL) 2034230

(51) Int. Cl. F16D 41/30; B62M 11/16; F16D 23/12; F16D 28/00; F16D 41/12

(52) U.S. Cl. CPC F16D 41/30; F16D 23/12; F16D 28/00; F16D 41/12; B62M 11/16

(57) ABSTRACT

A clutch system for a bicycle transmission. The clutch system includes a first clutch unit connectable to an input, including at least one first abutment surface and a second clutch unit connectable to an output, including at least one second abutment surface arranged for selectively engaging the first abutment surface. The first and second abutment surfaces being adapted to each other so as to allow disengaging under load. The system includes a third clutch unit arranged for selectively being in a first position or a second position relative to the second clutch unit, wherein at least one retaining member of the third clutch unit selectively locks the at least one second abutment surface in engagement with the at least one first abutment surface for selectively rotationally coupling the second clutch unit to the first clutch unit.

### FIELD OF THE INVENTION

The invention relates to a clutch system for a torque transmission for a bicycle.

### BACKGROUND TO THE INVENTION

Transmission systems for bicycles are known. In bicycles, especially racing bicycles, the transmission system traditionally includes a front derailleur and a rear derailleur, for shifting gears of the transmission system. Alternatives to derailleurs are formed by gear boxes, particularly at the hub and/or crank of the bicycle.

Such gear boxes can for example include one or more clutch systems for controlling a torque transmission path through the gear box so as to shift gears. An example of a clutch system is described in WO2018199757A2. This known clutch comprises a first rotatable unit having a first abutment surface, a second rotatable unit having a second abutment surface, and a third rotatable unit including a retaining member. The third rotatable unit is arranged for selectively being in a first position or a second position relative to the second rotatable unit. The retaining member in the first position locks the second abutment surface in engagement with the first abutment surface for rotationally coupling the second rotatable unit to the first rotatable unit, and in the second position releases the second abutment surface for disengagement of the first abutment surface for decoupling the second rotatable unit from the first rotatable unit.

### SUMMARY OF THE INVENTION

It is an object to provide an improved clutch system for a bicycle transmission, particularly a clutch system that is cost-effective, robust, can be manufactured with a small size, is easy to operate and/or is durable. Alternatively, or additionally, it is an object to provide a clutch system for a bicycle transmission which can be operated under load, e.g. while pedaling. Alternatively, or additionally, it is an object to provide a clutch system for a bicycle transmission which can be operated for coupling and for decoupling under load, e.g. while pedaling. Alternatively, or additionally, it is an object to provide a clutch system for a bicycle transmission which can be operated both for upshifting and for downshifting under load, e.g. while pedaling. More in general, it is an object to at least provide an alternative clutch system for a bicycle transmission.

According to an aspect is provided a clutch system for a bicycle transmission. Such clutch system can be used in a bicycle transmission. The clutch system has an input and an output. The input may be arranged for connection to a drive source, and the output may be arranged for connection to a load. The input can for example be arranged for connection to a rotary part of the transmission, and the output can for example be arranged for connection to a fixed part of the transmission, which fixed part is e.g. permanently non-rotatably fixed to a stationary part, such as an axle or housing, of the transmission. Preferably, the clutch system is operable under load between the input and the output. More preferably, the clutch system is operable under load between the input and the output both when coupling and when decoupling. Preferably, the clutch system is operable under load between the input and the output both during upshift and downshift of the bicycle transmission. The clutch system includes a first clutch unit, e.g. a first rotatable unit, connectable to the input or output. The clutch system includes a second clutch unit, e.g. a second rotatable unit, connectable to the output or input. It will be appreciated that the first clutch unit is connectable to one of the input or output, and that the second clutch unit is connectable to the other one of the input or output. In a particular example, the first clutch unit is connected to the input, and the second clutch unit is connected to the output. The first clutch unit includes at least one first abutment surface. The second clutch unit comprises a gripping member having a second abutment surface. The second abutment surface is arranged for selectively engaging the first abutment surface. The first and second abutment surfaces are adapted to each other so as to allow disengaging under load, e.g. so as to disengage under load. The clutch system includes a third clutch unit, e.g. a third rotatable unit. The third clutch unit can be arranged for co-rotating with the second clutch unit. The third clutch unit includes at least one retaining member. The third clutch unit is arranged for selectively being in a first position or a second position relative to the second clutch unit. It will be appreciated that the first position can be a first rotational and/or axial position, and the second position can be a second, different, rotational and/or axial position. The at least one retaining member in the first position locks the at least one second abutment surface in engagement with the at least one first abutment surface for rotationally coupling the second clutch unit to the first clutch unit. The at least one retaining member in the second position releases the at least one second abutment surface for disengagement of the at least one first abutment surface for decoupling the second clutch unit from the first clutch unit. The clutch system comprises a bearing, such as a rolling-contact bearing or a sliding-contact bearing, between the retaining member and the gripping member.

Hence, while the first and second abutment surfaces are adapted to each other so as to allow disengaging under load, or to disengage under load, the relative positioning of the second and third clutch units can in the first position lock the at least one second abutment surface in engagement with the at least one first abutment surface, and in the second position release the at least one second abutment surface for disengagement of the at least one first abutment surface. Hence, in the first position, the second clutch unit can be rotationally coupled to the first clutch unit, and in the second position the second clutch unit can be decoupled from the first clutch unit. Thus a simple and efficient clutch system can be provided.

If one of the first clutch unit and the second clutch unit were to be held stationary in use, the clutch system may be considered to function as a brake system in which the other one of the first clutch unit and the second clutch unit is clutched to the stationary clutch unit, i.e. ‘braked’. The clutch system described herein may hence also be considered a brake system.

The bearing between the retaining member and the gripping member facilitates movement of the third clutch unit relative to the second clutch unit in particularly when transitioning between an engaged state and a disengaged state of the clutch system. A frictitious contact between the retaining member and the gripping member can hence be replaced by a friction-reducing element, e.g. the bearing, particularly at those instances where normal forces between the gripping member and retaining member are relatively high, such as where the retaining member locks the gripping member in engagement with the first clutch unit. This consequently allows an actuation power for the clutch system to be reduced significantly.

Each of the first clutch unit, the second clutch unit, and the third clutch unit may be a rotatable unit. The first clutch unit, the second clutch unit, and the third clutch unit may for example be rotatable about a common rotation axis. The first clutch unit and the second clutch unit may be rotatable relative to one another in the second position and not rotatatable relative to one in the first position. One of the first clutch unit and the second clutch unit may be a stationary unit, while the other one of the first clutch unit and the second clutch unit may be a rotatable unit. For example, the second clutch unit may be a stationary unit that is non-rotatably mounted to a stationary part of the bicycle transmission, such an axle or housing, while the first clutch unit may be a rotatable unit that is rotatable relative to the second clutch unit in the second position. The third clutch unit may be rotatable relative to the second clutch unit. The third clutch unit may also be rotatable relative to the first clutch unit. The third clutch unit may hence be a rotatable unit.

Optionally, the third clutch unit is arranged for co-rotating with the second clutch unit, and the system is arranged for temporarily changing rotation speed of the third clutch unit relative to the second clutch unit, e.g. by temporarily speeding up, braking or halting the second and/or third clutch unit, for rotating from the first position to the second position, or from the second position to the first position.

Optionally, the second clutch unit is permanently stationary, and the system is arranged for rotating the third clutch unit relative to the second clutch unit from the first position to the second position and/or form the second position to the first position.

Optionally, the clutch system includes an actuator for rotating the third clutch unit and/or the second clutch unit from the first position to the second position, and/or from the second position to the first position. The actuator can be triggerable from outside the clutch system, such as via a control unit. The actuator can e.g. be triggered by external means. The actuator can e.g. be triggered by electrical means or mechanical means. The actuator can e.g. be triggered by manual means such as a user operated button or lever. The actuator can e.g. be triggered by automatic means, such as a controller. The clutch system can include input means. The input means can be arranged for receiving a trigger for triggering the actuator. Triggering of the actuator can be independent of internal forces, torques and/or rotational speeds in the clutch system. Hence, the clutch system can be operated under control of a user or user device.

Optionally, the clutch system includes an actuator for rotating the third clutch unit and/or the second clutch unit from the first position to the second position, and/or from the second position to the first position.

Optionally, in the first position, the retaining member is substantially radially aligned with the gripping member for retaining the second abutment surface in an engagement position for engaging the first abutment surface, and in the second position, the retaining member is radially unaligned with the gripping member for releasing the second abutment surface from the engagement position.

Optionally, the rolling-contact bearing includes a roller which is rotatably mounted to the gripping member for being in rolling-contact with the retaining member or an element associated therewith, or wherein the rolling-contact bearing includes a roller which is rotatably mounted to the retaining member for being in rolling-contact with the gripping member or an element associated therewith.

Optionally, the first, second and/or third clutch unit are coaxial. The first clutch unit, the second clutch unit and the third clutch unit may for example be coaxial with respect to a common rotation axis about which one or more of the first clutch unit, the second clutch unit and the third clutch unit are rotatable.

Optionally, the third clutch unit is at least partially positioned within the second clutch unit, and/or the second clutch unit is at least partially positioned within the first clutch unit.

Optionally, the first clutch unit is at least partially positioned within the second clutch unit, and/or the second clutch unit is at least partially positioned within the third clutch unit.

Optionally, the third clutch unit is eccentrically arranged relative to the second clutch unit and/or the first clutch unit. The third clutch unit may for example be coaxial with the first and/or second clutch unit and eccentrically arranged relative to the first and/or second clutch unit.

Optionally, the third clutch unit comprises a rotatable cam, and wherein the retaining member is formed by a lobe of the rotatable cam.

Optionally, a cross section of the rotatable cam has a smooth continuous engagement surface. The cross section of the rotatable cam may particularly be free from sharp corners and/or flat sections. Hence, actuation of the clutch between engagement and disengagement may be smooth and gradual, providing more control and predictability.

Optionally, a cross section of the rotatable cam has a convex shape.

Optionally, the rotatable cam has a circular cross section. The rotatable cam may for example be disc-shaped. Such cam may be particularly be cost-effectively produced. Furthermore, a circular cam provides an effective smoot shape of the outer contour for allowing smooth and gradual engagement and disengagement of the gripping member.

Optionally, the bearing comprises a pair of concentric bearing races surrounding the, e.g. circular, rotatable cam, wherein a first one, e.g. an inner one, of the pair of bearing races is associated with, e.g. formed by, the rotatable cam and a second one, e.g. an outer one, of the pair of bearing races is arranged for being in engagement with the gripping member, in particular when the retaining member locks the second abutment surface in engagement with the first abutment surface. A circular shape of the cam particularly enables mounting of a standard bearings thereto, reducing overall production cost of the clutch system.

Optionally, the second one of the pair of bearing races and the gripping member are arranged for being in non-slipping engagement with one another, particular at or near the first position.

Optionally, the first one of the pair of bearing races is arranged for corotating with the rotatable cam. The first one of the pair of bearing races may for instance be fixed to the rotatable cam, or integrally formed with the rotatable cam.

Optionally, one or more rollers are arranged between the pair of concentric bearing races, hence providing a rolling-contact between the gripping member and the retaining member.

Optionally, the pair of concentric bearing races are in sliding contact with each other, hence providing a sliding-contact bearing between the gripping member and the retaining member.

Optionally, the rolling-contact bearing comprises a pair concentric bearing races coupled to the gripping member, wherein a first one, e.g. an inner one, of the pair of bearing races is fixed to the gripping member, and a second one, e.g. an outer one, of the pair of bearing races is arranged for being in engagement with the retaining member, in particular when the retaining member locks the second abutment surface in engagement with the first abutment surface.

Optionally, the second one of the pair bearing races and the retaining member are arranged for being in non-slipping engagement with one another, particular at or near the first position.

Optionally, one or more rollers are arranged between the pair of concentric bearing races, hence providing a rolling-contact between the gripping member and the retaining member.

Optionally, the pair of concentric bearing races are in sliding contact with each other, hence providing a sliding-contact bearing between the gripping member and the retaining member.

Optionally, the gripping member comprises a first gripping member part having the second abutment surface and a second gripping member part hingedly connected to the first gripping member part and arranged for being in bearing-contact with the retaining member.

Optionally, the rotatable cam is bearing mounted to an axle, e.g. by a further bearing. The further bearing may be a sliding-contact bearing and/or a rolling contact bearing. The further bearing may for example be a further rolling-contact bearing comprising a pair of concentric bearing races surrounding the axle, and one or more rollers arranged between the two concentric bearing races. A first one, e.g. an inner one, of the two bearing races may be associated with the axle, and a second one, e.g. an outer one, of the two races may be associated with the third clutch unit, e.g. the rotatable cam. Hence, a further bearing may be arranged between the third clutch unit, e.g. the rotatable cam, and the axle. The axle may be a stationary axle, e.g. non-rotatably mounted to a stationary part such as a housing or a bicycle frame. The axle may alternatively be rotatable. The further bearing may facilitate rotation of the third clutch unit relative to the axle, to reduce the overall actuation power requirement of the clutch system.

Optionally, the, e.g. circular, rotatable cam is eccentrically bearing mounted to the axle. Hence, a geometric center of the, e.g. circular, rotatable cam is offset its rotation axis which particularly coincides with the longitudinal direction of the axle.

Optionally, the axle is concentrically arranged with respect to the first and second clutch units.

Optionally, the axle is arranged for co-rotating with the second clutch unit. The axle and the second clutch unit may hence be interconnected or integrated with one another. Optionally, the axle is non-rotatably fixed to a stationary part, such a bicycle frame or housing. The second clutch unit may be mounted to the axle, and may hence also be stationary.

Optionally, the second clutch unit comprises at most two gripping members, in particular at most one gripping member.

Optionally, the third clutch unit comprises at most two retaining members, in particular at most one retaining member.

Optionally, the gripping member of the second clutch unit is hingedly connected to a remainder of the second clutch unit, and wherein the gripping member is furthermore translatable relative to the remainder of the second clutch unit along a predefined translation path. Hence, the clutch system is provided with a degree of compliance, minimizing the risk of lock-up of the clutch system.

Optionally, the gripping member is resiliently translatable relative to the remainder of the second clutch unit along the predefined translation path.

Optionally, the third clutch unit is rotatable relative to the second clutch unit. Optionally a rotation angle of the third clutch unit relative to the second clutch unit is more than 360 degrees. Optionally a rotation angle of the third clutch unit relative to the second clutch unit is unlimited. The clutch system can be free from stop means limiting the rotation angle of the third clutch unit relative to the second clutch unit.

Optionally, the third clutch unit is arranged to be rotated relative to the second clutch unit from the first position to the second position, and from the second position to the first position in one and the same rotational direction. The third clutch unit can be rotated relative to the second clutch unit in a continued forward rotation for being moved from the first position to the second position, and from the second position to the first position. The third clutch unit can be rotated relative to the second clutch unit in a continued rearward rotation for being moved from the first position to the second position, and from the second position to the first position.

Optionally, the first position is part of a first position range, wherein the retaining member in the first position range position locks the second abutment surface in engagement with the first abutment surface for rotationally coupling the second clutch unit to the first clutch unit.

Optionally, the second position is part of a second position range, wherein the retaining member in the second position range releases the second abutment surface for disengagement of the first abutment surface for decoupling the second clutch unit from the first clutch unit.

Optionally, the third clutch unit is arranged for selectively being in one of a plurality of first or second positions relative to the second clutch unit. The third clutch unit in each of the first positions of the plurality of first positions locks the second abutment surface in engagement with the first abutment surface for rotationally coupling the second clutch unit to the first clutch unit. The third clutch unit in each of the second positions of the plurality of second positions releases the second abutment surface for disengagement of the first abutment surface for decoupling the second clutch unit from the first clutch unit. The third clutch unit can be arranged to be rotated relative to the second clutch unit from a first first position to a first second position, and from the first second position to a second first position in one and the same rotational direction. The third clutch unit can be arranged to be rotated relative to the second clutch unit from the second first position to a second second position, and from the second second position to a third first position (or to a third first position) in the same one and the same rotational direction. The first positions of the plurality of first positions can e.g. be equally spaced around the perimeter of the second clutch unit. The second positions of the plurality of second positions can e.g. be equally spaced around the perimeter of the second clutch unit. The first positions and second positions can be alternatingly and preferably equally spaced around the perimeter of the second clutch unit. For example, three first positions and three second positions are alternatingly spaced at 60 degrees around the perimeter of the second clutch unit.

Optionally, the second and third clutch units are free from biasing force relative to each other, such that the third clutch unit is not forced into a first or second position relative to the second clutch unit by a force, such as a spring force.

Optionally, the second and third clutch units are biased relative to each other towards a stable relative position.

Optionally, the engagement or disengagement of the second abutment surface with the at least one first abutment surface is independent of input torque and/or rotation speed, but relies only on the second and third clutch units being in the first or second relative positions.

Optionally, the at least one second abutment surface of the second clutch unit is hingedly connected to the remainder of the second clutch unit.

Optionally, the at least one second abutment surface of the second clutch unit is hingedly connected to the remainder of the second clutch unit so as to have a single pivot axis.

Optionally, the first and/or second abutment surface is biased to disengage. Hence the default for the first and second abutment surfaces is a disengaged mode. The relative position of the third and second clutch units then determined whether or not the first and second abutment surfaces are engaged or disengaged.

According to an aspect, a clutch system for a bicycle transmission is provided having an input and an output. The clutch system including a first clutch unit connectable to the input or output, including a first abutment surface; a second clutch unit connectable to the output or input, including a gripping member having a second abutment surface arranged for selectively engaging the first abutment surface, the first and second abutment surfaces being adapted to each other so as to allow disengaging under load; a third clutch unit including a retaining member, the third clutch unit being arranged for selectively being in a first position or a second position relative to the second clutch unit, wherein the retaining member in the first position locks the second abutment surface in engagement with the first abutment surface for rotationally coupling the second clutch unit to the first clutch unit, and in the second position releases the second abutment surface for disengagement of the first abutment surface for decoupling the second clutch unit from the first clutch unit. A rolling-contact is provided between the retaining member and the gripping member, particular when the retaining member is at or near the first position. The rolling-contact may for example be provided by a rolling-contact bearing as described herein, arranged between the retaining member and the gripping member.

According to an aspect, a clutch system for a bicycle transmission is provided having an input and an output. The clutch system includes a first clutch unit connectable to the input, including a first abutment surface. The clutch system includes a second clutch unit connectable to the output, including a gripping member having a second abutment surface arranged for selectively engaging the first abutment surface, the first and second abutment surfaces being adapted to each other so as to allow disengaging under load. The clutch system includes a third clutch unit including a retaining member, the third clutch unit being arranged for selectively being in a first position or a second position relative to the second clutch unit, wherein the retaining member in the first position locks the second abutment surface in engagement with the first abutment surface for rotationally coupling the second clutch unit to the first clutch unit, and in the second position releases the second abutment surface for disengagement of the first abutment surface for decoupling the second clutch unit from the first clutch unit. A first one of the first clutch unit and the second clutch unit is a non-rotatable clutch unit, and a second one of the first clutch unit and the second clutch unit is a rotatable clutch unit rotatable relative to the first one of the first clutch unit and the second clutch unit. The third clutch unit is a rotatable clutch unit that is rotatable relative to the first one of the first clutch unit and the second clutch unit. The non-rotatable first one of the first clutch unit and the second clutch unit may be non-rotatably fixed to a stationary part of the bicycle transmission, such as a housing or axle. Hence, the second one of the first clutch unit and the second clutch unit can be selectively braked, by coupling to the, non-rotatable, first one of the first clutch unit and the second clutch unit. The clutch system may hence also be referred to as a brake system.

Optionally, the second clutch unit is the non-rotatable clutch unit. Hence, the first clutch unit and the third clutch unit are rotatable relative to the second stationary clutch unit.

According to an aspect is provided a clutch assembly comprising a first clutch system as described herein and a second clutch system as described herein. The first clutch system has a first second clutch unit including a first gripping member, and a first third clutch unit including a first retaining member. The second clutch system has a second second clutch unit including a second gripping member, and a second third clutch unit including a second retaining member. The first third clutch unit and the second third clutch unit are co-rotatingly coupled to one another.

Optionally, the clutch assembly comprises a biasing element configured for biasing the first third clutch unit and the second third clutch unit relative to each other towards a stable relative position.

Optionally, the first third clutch unit and the second third clutch unit are actuated or actuatable in rotation by a common actuator. The common actuator may for example be single electric motor having an output that is connected to the first and second third clutch units, for driving the first and second third clutch units in rotation.

Optionally, the first third clutch unit and the second third clutch unit are angularly so arranged relative to one another that the first retaining member and the second retaining member are in angular alignment with each other. Hence, the first and second retaining members are positioned in the same angular orientation, and not angularly staggered with respect to each other. Alternatively, the first third clutch unit and the second third clutch unit are angularly so arranged relative to one another that the first retaining member and the second retaining member are angularly staggered with respect to one another. For example, the first retaining member and the second retaining member may be angularly spaced from one another, e.g. by a fixed predetermined angular spacing.

Optionally, the first third clutch unit and the second third clutch unit are integrated with one another, particularly such that the first retaining member and the second retaining member form an integrated retaining member for cooperating with the first gripping member and the second gripping member. In particular if the first and second third clutch units have a circular cross section, the first and second third clutch units may be formed as a cylindrical shaft. The cylindrical shaft may for example have an eccentric rotation axis, i.e. the rotation axis about which the cylindrical shaft is rotatably drivable may be offset from a geometric center of the cylindrical shaft.

Optionally, the first gripping member and the second gripping member are angularly staggered with respect to one another, particularly wherein the first clutch system and the second clutch system each include only one or only two gripping members. The angular staggering of the first and second gripping member allows for selective engagement and disengagement of the first clutch system and the second clutch system. For example, if the first and second retaining members are angularly non-staggered with respect to each other, the angular spacing between the first and second gripping members can determine the selectivity and order of engagement and disengagement of the first and second clutch systems. Alternatively, the first gripping member and the second gripping member may be be in angular alignment with each other.

Optionally, the clutch assembly is movable between a first state and a second state, wherein in the first state, the first third clutch unit is in the first position while the second clutch unit is in the second position, and in the second state, the first third clutch unit is in the second position while the second third clutch unit is in the first position. Hence, in the first state, the first clutch system is engaged and the second clutch system is disengaged, wherein in the second state, the first clutch system is disengaged and the second clutch system is engaged. The clutch assembly includes a third state in which both the first third clutch unit and the second third clutch unit are in their respective first positions. Hence, in the third state, both the first clutch system and the second clutch system are engaged. In the third state, only one of the first and second clutch systems may transfer torque, e.g. an overrunning freewheel may be arranged in a transmission path associated with the non-torque-transferring clutch system.

Optionally, the clutch assembly further includes a fourth state in which both the first third clutch unit and the second third clutch unit are in their respective second positions. Hence, in the fourth state, both the first clutch system and the second clutch system are disengaged. The third state may for example be associated with a unitary transmission ratio.

Optionally, clutch assembly is movable between the first state and the second state, via the third or fourth state, by a rotation of the first and second third clutch units relative to the first and second second clutch units by a predetermined angle. Hence, for example when actuating the disengagement of the first clutch system and engagement of the second clutch system, the second clutch system is engaged prior to the disengagement of the first clutch system. Further, for example, when actuating the engagement of the first clutch system and disengagement of the second clutch system, the first clutch system is engaged prior to the disengagement of the second clutch system. This provides a smooth and instant shift experience for a rider of the bicycle.

Optionally, the predetermined angle is at most 90 degrees. The predetermined angle is for example approximately 90 degrees.

Optionally, the first gripping member and the second gripping member are angularly staggered from one another by an angle of at most 90 degrees. Each of the first and second clutch systems may particularly have only one gripping member.

Optionally, the first clutch system and the second clutch system each has a separate rolling-contact bearing. Each of the first clutch system and the second clutch system hence can have a dedicated rolling-contact bearing between the respective retaining member and associated gripping member.

Optionally, the first clutch system and the second clutch system share a common rolling-contact bearing. Hence, the common rolling-contact bearing can be arranged between the first and second retaining members on the one hand and the first and second gripping members on the other hand. This provides a robust and cost-effective construction, that can be efficiently operated.

Optionally, the common rolling-contact bearing comprises a first bearing race for being associated with the first and second third clutch units, and a second bearing race for being in engagement with the first and second second clutch unit, and rollers arranged between the first bearing race and the second bearing race.

According to an aspect, a clutch assembly is provided such as described herein, comprising: a first first clutch unit having a first first abutment surface; a second first clutch unit having a second first abutment surface, the first first clutch unit and the second first clutch unit being rotatable relative to each about an axis; an integrated second clutch unit comprising a first gripping member and a second gripping member, the first gripping member having a first second abutment surface arranged for selectively engaging the first first abutment surface, and the second gripping member having a second second abutment surface arranged for selectively engaging the second first abutment surface; an integrated third clutch unit comprising a first retaining member and a second retaining member, wherein the clutch assembly is movable between a first state and a second state, wherein, the first retaining member in the first state locks the first second abutment surface in engagement with the first first abutment surface for rotationally coupling the first first clutch unit to the integrated second clutch unit, and the first retaining member in the second state releases the first second abutment surface for disengagement from the first first abutment surface for decoupling the first first clutch unit from the integrated second clutch unit, and wherein the second retaining member in the first state releases the second second abutment surface for disengagement from the second first abutment surface for decoupling the second first clutch unit from the integrated second clutch unit, and the second retaining member in the second state locks the second second abutment surface in engagement with the second first abutment surface for rotationally coupling the second first clutch unit to the integrated second clutch unit.

Optionally, the integrated second clutch unit or the integrated third clutch unit is, e.g. permanently, non-rotatably fixed to a stationary part, such as a stationary axle. The stationary axle may for example be non-rotatably mounted to frame of the bicycle or a transmission housing.

According to an aspect is provided a bicycle transmission system, including a clutch system and/or clutch assembly as described herein and a transmission, e.g. comprising a planetary gear, selectively operable according to a selective one of a plurality of transmission ratios. The transmission system can be arranged in the bicycle transmission, e.g. so as to selectively shift the transmission from one transmission ratio to another and/or vice versa, such by coupling two of the sun gear, the planet carrier and the ring gear of the planetary gear. Optionally, The clutch system is arranged in the bicycle transmission so as to selectively couple the planet carrier and the ring gear.

Optionally, the transmission comprises a planetary gear having three rotational members, such as a sun gear, a planet carrier carrying one or more planet gears, and a ring gear, wherein the clutch system is arranged for selectively coupling and/or decoupling one of the three rotational members to an axle.

Optionally, the clutch system is arranged for selectively coupling and/or decoupling the sun gear to the axle.

Optionally, the planetary gear comprises a plurality of sun gears, and wherein the one or more planet gears are stepped planet gears each including a plurality of different planet radii, wherein each sun gear cooperates with the stepped planet gear at a respective radius of the plurality of different radii.

Optionally, the stepped planet gear comprises at least three planet different planet radii, particularly at least four different planet radii.

Optionally, a plurality of said clutch systems, each clutch system being associated with a respective sun gear and arranged for selectively coupling and/or decoupling the respective sun gear to the axle.

Optionally, a single-radius ring gear cooperating with the stepped planet gear at a single one of the plurality of planet radii.

According to an aspect is provided a wheel axle assembly, such as a bicycle wheel axle assembly, including the transmission system. The wheel axle assembly can be arranged for receiving a cassette having a plurality of gear wheels.

According to an aspect is provided a bicycle wheel hub including a clutch system as described herein. The bicycle wheel hub can include a transmission system, as described. Optionally, the wheel hub is arranged for receiving a cassette having a plurality of gear wheels.

According to an aspect is provided a crank axle assembly, such as a bicycle crank axle assembly, including the transmission system.

According to an aspect is provided a bicycle including a clutch system and/or clutch assembly as described herein. The bicycle can include a transmission system, including a clutch system as described herein and a planetary gear. The clutch system can be arranged in the transmission system so as to selectively couple two of the sun gear, the planet carrier and the ring gear. Optionally, The clutch system is arranged in the transmission system so as to selectively couple the planet carrier and the ring gear. Optionally, the transmission system is included in a rear wheel hub of the bicycle. Optionally, a rear cassette having a plurality of gear wheels is attached to the rear wheel hub. The bicycle can include a rear derailleur for selecting one of the plurality of gear wheels of the rear pinion. Optionally, the bicycle includes one single front pinion. In such case, the bicycle transmission can emulate functioning of a front derailleur.

According to an aspect is provided a method for operating a clutch system for a bicycle transmission. Such method can be practiced in a bicycle. The clutch system has an input, e.g. arranged for connection to a drive source, and an output, e.g. arranged for connection to a load. Preferably, the clutch system is operable under load between the input and the output. More preferably, the clutch system is operable under load between the input and the output both when coupling and when decoupling. Preferably, the clutch system is operable under load between the input and the output both during upshift and downshift of the bicycle transmission. The method includes providing a clutch system. The clutch system includes a first clutch unit, e.g. a housing, connectable to the input or output. The clutch system includes a second clutch unit connectable to the output or input. It will be appreciated that the first clutch unit is connectable to one of the input or output, and that the second clutch unit is connectable to the other one of the input or output.clutch unitclutch unit The first clutch unit includes at least one first abutment surface. The second clutch unit includes a gripping member having at least one second abutment surface arranged for selectively engaging the first abutment surface. The first and second abutment surfaces are adapted to each other so as to allow disengaging under load, e.g. so as to disengage under load. The clutch system includes a third clutch unit. The third clutch unit can be arranged for co-rotating with the second clutch unit. The third clutch unit includes at least one retaining member. The third clutch unit is arranged for selectively being in a first position or a second position relative to the second clutch unit. It will be appreciated that the first position can be a first rotational and/or axial position, and the second position can be a second, different, rotational and/or axial position. The third clutch unit in the first position locks the at least one second abutment surface in engagement with the at least one first abutment surface for rotationally coupling the second clutch unit to the first clutch unit. The third clutch unit in the second position releases the at least one second abutment surface for disengagement of the at least one first abutment surface for decoupling the second clutch unit from the first clutch unit. The clutch system comprises a rolling-contact bearing between the retaining member and the gripping member. The method includes rotating the third clutch unit relative to the second clutch unit from a first position to a second position for disengaging the clutch system, and rotating the third clutch unit relative to the second clutch unit from a second position to a first position for engaging the clutch system.

Optionally, the method includes having the third clutch unit co-rotate with the second clutch unit, and temporarily changing rotation speed of the third clutch unit relative to the second clutch unit, e.g. by temporarily speeding up, braking or halting the second and/or third clutch unit, for rotating the third clutch unit from the first position to the second position, or from the second position to the first position, relative to the second clutch unit.

Optionally, the method includes automatically resuming co-rotation of the third clutch unit with the second clutch unit after the third clutch unit has been rotated from the first rotational position to the second rotational position or vice versa.

According to an aspect is provided a method for operating a clutch assembly for a bicycle transmission having an input, e.g. arranged for connection to a drive source, and an output, e.g. arranged for connection to a load. The method includes providing a clutch assembly such as described herein, including a first clutch system and a second clutch system. Any one or more of the first and second clutch systems may be a clutch system as described herein. The first and second clutch system each comprise a first clutch unit connectable to the input or output; a second clutch unit connectable to the output or input; and a third clutch unit, e.g. arranged for co-rotating with the second clutch unit. The third clutch unit is arranged for selectively being in a first rotational position or a second rotational position relative to the second clutch unit, wherein the system is arranged for selectively in the first rotational position rotationally coupling the second clutch unit to the first clutch unit for engaging the clutch system, and in the second rotational position decoupling the second clutch unit from the first clutch unit for disengaging the clutch system. Each of the first and second clutch system comprises a rolling-contact bearing between the retaining member and the gripping member. The third clutch units of the first and second clutch systems are co-rotatingly coupled to one another. The method includes disengaging the first clutch system and engaging the second clutch system, and/or vice versa, by co-rotating said third clutch units relative to the second clutch units.

Optionally, the third clutch units are co-rotated in only one rotational direction.

According to an aspect, a method is provided for operating a clutch assembly for a bicycle transmission having an input, e.g. arranged for connection to a drive source, and an output, e.g. arranged for connection to a load. The method comprises providing a clutch assembly, such as described herein, including a first clutch system and a second clutch system. Any one or more of the first and second clutch systems may be a clutch system as described herein. Each of the first and second clutch systems comprises a first clutch unit connectable to the input or output; a second clutch unit connectable to the output or input; and a third clutch unit, e.g. arranged for co-rotating with the second clutch unit, the third clutch unit being arranged for selectively being in a first rotational position or a second rotational position relative to the second clutch unit, wherein the system is arranged for selectively in the first rotational position rotationally coupling the second clutch unit to the first clutch unit for engaging the clutch system, and in the second rotational position decoupling the second clutch unit from the first clutch unit for disengaging the clutch system. Each of the first and second clutch systems comprises a rolling-contact bearing between the retaining member and the gripping member. The third clutch units of the first and second clutch systems are co-rotatingly coupled to one another. The method comprises disengaging the first clutch system and disengaging the second clutch system by co-rotating said third clutch units relative to the second clutch units.

Optionally, the third clutch units are co-rotated in only one rotational direction.

According to an aspect a method is provided for operating a clutch assembly for a bicycle transmission having an input, e.g. arranged for connection to a drive source, and an output, e.g. arranged for connection to a load. The method comprises providing a clutch assembly such as described herein including a first clutch system and a second clutch system. Any one or more of the first and second clutch systems may be clutch system as described herein. Each of the first and second clutch systems comprises a first clutch unit connectable to the input or output;
a second clutch unit connectable to the output or input; and a third clutch unit, e.g. arranged for co-rotating with the second clutch unit, the third clutch unit being arranged for selectively being in a first rotational position or a second rotational position relative to the second clutch unit, wherein the system is arranged for selectively in the first rotational position rotationally coupling the second clutch unit to the first clutch unit for engaging the clutch system, and in the second rotational position decoupling the second clutch unit from the first clutch unit for disengaging the clutch system. Each of the first and second clutch systems comprises a rolling-contact bearing between the retaining member and the gripping member. The third clutch units of the first and second clutch systems are co-rotatingly coupled to one another. The method comprises, by co-rotating the third clutch units relative to the second clutch units: disengaging the first clutch system and engaging the second clutch system, and/or engaging the first clutch system and disengaging the second clutch system, and/or disengaging the first clutch system and disengaging the second clutch system, and/or engaging the first clutch system and engaging the second clutch system.

Optionally, the third clutch units are co-rotated in only one rotational direction.

It will be appreciated that any one or more of the above aspects, features and options can be combined. It will be appreciated that any one of the options described in view of one of the aspects can be applied equally to any of the other aspects. It will also be clear that all aspects, features and options described in view of the clutch system apply equally to the method, and vice versa.

### BRIEF DESCRIPTION OF THE DRAWING

The invention will further be elucidated on the basis of exemplary embodiments which are represented in a drawing. The exemplary embodiments are given by way of non-limitative illustration. It is noted that the figures are only schematic representations of embodiments of the invention that are given by way of non-limiting example.

In the drawing:

FIGS. 1A-9B show examples of a clutch system;

FIG. 10 shows an example of a clutch system;

FIGS. 11A-11D show an example of a clutch assembly;

FIG. 12 shows an example of a hub assembly having a bicycle transmission;

FIG. 13 shows a bicycle.

### DETAILED DESCRIPTION

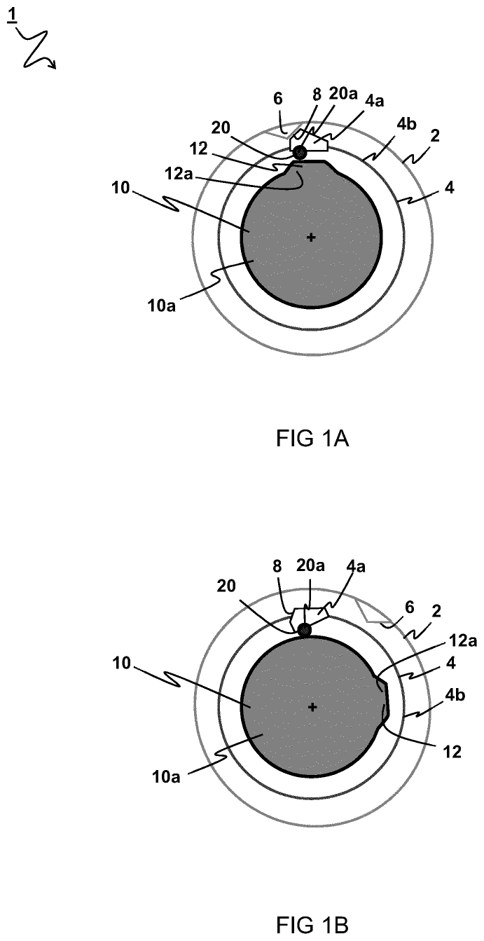

FIGS. 1A-9B show examples of a clutch system 1. FIGS. 1A, 2A, 3A, 4A, 5A, 6A, 7A, 8A and 9A, will hereinafter be collectively referred to as Figures A. FIGS. 1B, 2B, 3B, 4B, 5B, 6B, 7B, 8B and 9B, will hereinafter be collectively referred to as Figures B. The clutch system 1 of these examples is for use in a bicycle transmission of a bicycle. The clutch system 1 has an input and an output. The input may be arranged for connection to a drive source, such as pedals or a chain/belt. The output may be arranged for connection to a load, such as chain or a rear wheel hub. The input can also be arranged for connection to a rotary part of the transmission, and the output can be arranged for connection to a fixed part of the transmission, which fixed part is e.g. permanently non-rotatably fixed to a stationary part, such as an axle or housing, of the transmission. The exemplary clutch system 1 is operable under load between the input and the output, e.g. while pedaling. Hence, the clutch system 1 can be coupled or decoupled under load. Here, the clutch system is operable under load between the input and the output both during upshift and downshift of the bicycle transmission.

The clutch system in FIGS. 1-9 includes a first clutch unit 2. The first clutch unit 2 is here arranged to be connected to the output. Here, the first clutch unit 2 is designed as a housing part of the clutch system 1. The clutch system 1 includes a second clutch unit 4. The second clutch unit 4 is here arranged to be connected to the input. The first clutch unit 2 includes at least one first abutment surface 6. In this example, the first clutch unit 2 includes a plurality of first abutment surfaces 6, evenly distributed along the perimeter of the first clutch unit 2. FIGS. 1-9 show only one first abutment surface 6 for clarity. The second clutch unit 4 includes at least one second abutment surface 8. In these examples, the second clutch unit has only one second abutment surface 8. In alternative examples however, the first clutch unit 2 may include more than one second abutment surface, such as only two second abutment surfaces, only three second abutment surfaces, only four second abutment surfaces, only five second abutment surfaces, or more than five second abutment surfaces. In an example, the second clutch unit 4 includes three second abutment surfaces 8, evenly distributed along the perimeter of the second clutch unit 4 at 120 degrees mutual spacing. In another example, the second clutch unit 4 includes two second abutment surfaces 8, evenly distributed along the perimeter of the second clutch unit 4 at 180 degrees mutual spacing. The second abutment surface 8 is here formed by a gripping member 4a. Here, the second clutch unit 4 has only one gripping member 4a, but it will be appreciated that the second clutch unit 4 may include a plurality of gripping members 4a. Here the gripping member 4a is embodied as separate parts hingedly connected to a body portion 4b of the second clutch unit 4. In this example, the second abutments surface 8 is part of the gripping member 4a of the second clutch unit 4. The second abutment surface 8, here formed by the gripping member 4a, is arranged for selectively engaging one of the first abutment surfaces 6. The first and second abutment surfaces are oriented at an angle relative to a radial direction of the first and second clutch units, respectively. This enables the first and second abutment surfaces to disengage under load.

The clutch system 1 also includes a third clutch unit 10. The third clutch unit 10 includes at least one retaining member 12. In these examples, the third clutch unit 10 includes only one retaining member 12, but it will be appreciated that the third clutch unit 10 may include more than one retaining member, such as only two retaining members, only three retaining members, only four retaining members or only five retaining members, for example evenly distributed along the perimeter of the third clutch unit 10 at equal degrees mutual spacing. The third clutch unit 10 is arranged for selectively being in a first position (see Figures A) or a second position (see Figures B) relative to the second clutch unit 4. It will be appreciated that in this example the first position is a first rotational position, and the second position is a second, different, rotational position.

In the first position (shown in Figures A), the retaining member 12 is positioned rotationally aligned with the gripping member 4a. Thus, in the first position, the gripping member 4a is forced to be pivoted in a radially outer position. In the first position, the second abutment surface 8 is positioned to be touching or close to the first abutment surface 6. The presence of the retaining member 12 under the gripping member 4a prevents the second abutment surface 8 from being pivoted radially inwards sufficiently to disengage from the first abutment surface 6. Hence, the retaining member 12 in the first position locks the second abutment surfaces 8 in engagement with the first abutment surfaces 6. As the second abutment surface 8 is locked in engagement with the first abutment surface 6, the second clutch unit 4 is rotationally coupled to the first clutch unit 2. Would it not be for the presence of the retaining member 12 preventing the gripping member 4a to move radially inwards, the second abutment surface 8 would disengage from the first abutment surface 6 when a rotational load is applied to the first clutch unit 2 and/or second clutch unit 4.

In the second position (shown in Figures B), the retaining member 12 is positioned rotationally not aligned with the gripping member 4a. Thus, in the second position, the gripping member 4a is free to pivot to a radially inner position. In this example, a biasing force of a resilient member pivots the gripping member 4a with second abutment surface 8 radially inwards sufficiently to disengage from the first abutment surface 6. As a result, the first clutch unit 2 is free to rotate independently of the second clutch unit 4. Thus, in the second position the second clutch unit 4 is decoupled from the first clutch unit 2.

Hence, while the first abutment surface 6 and second abutment surface 8 are adapted to each other so as to allow engaging and disengaging under load, the relative positioning of the second clutch unit 4 and the third clutch unit 10 can selectively in the first position lock the second abutment surface 8 in engagement with the first abutment surface 6, and in the second position release the second abutment surface 8 for disengagement from the first abutment surface 6. It will be appreciated that while the first clutch unit 2 and second clutch unit 4 are decoupled, rotating the third clutch unit 10 from the first position to the second position relative to the second clutch unit 4, will couple the first and second clutch units. While the first clutch unit 2 and second clutch unit 4 are coupled, rotating the third clutch unit 10 from the second position to the first position relative to the second clutch unit 4, will decouple the first and second clutch units.

Changing the position of the third clutch unit 10 relative to the second clutch unit 4 from the first position to the second position, or vice versa, can be performed in many different ways. Changing the position of the third clutch unit 10 relative to the second clutch unit 4 from the first position to the second position can be performed by rotating the third clutch unit 10 relative to the second clutch unit 4 in a forward direction, and changing the position of the third clutch unit 10 relative to the second clutch unit 4 from the second position to the first position can be performed by rotating the third clutch unit 10 relative to the second clutch unit 4 in an opposite, rearward direction. It is also possible to rotate the third clutch unit 10 relative to the second clutch unit 4 from the first position to the second position, and from the second position to the first position in one and the same rotational direction. Instead of rotating, or in addition, the third clutch unit 4 can also be axially translated from the first position to the second position and/or vice versa.

An actuator can be provided for rotating the third clutch unit and/or the second clutch unit from the first position to the second position, and/or from the second position to the first position.

In some examples, the third clutch unit 10 can be arranged for co-rotating with the second clutch unit 4. Therefore, changing the position of the third clutch unit 10 relative to the second clutch unit 4 from the first position to the second position, or vice versa, can be performed by temporarily changing rotation speed of the third clutch unit relative to the second clutch unit, e.g. by temporarily speeding up, braking or halting the second and/or third clutch unit, for rotating from the first position to the second position, or from the second position to the first position.

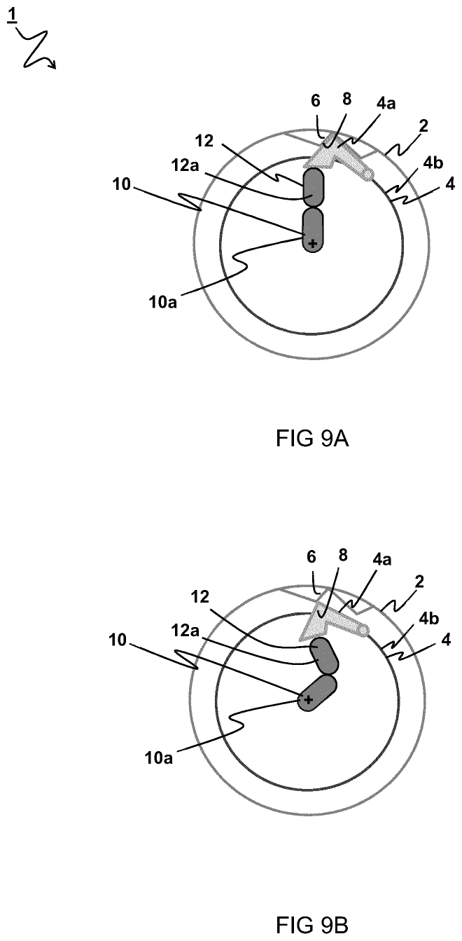

FIGS. 9A and 9B shows an example of a clutch system 1, wherein the lobe 12a and the cam 10a are in rolling contact with each other. The lobe 12a is in turn also in rolling contact with the gripping member 4a. The lobe 12a may hence be considered to be formed as a roller 20a. In this example, the lobe 12a has an elongated shape. The third clutch unit 10 may be biased in a position as shown in FIG. 9A, in which elongated lobe 12a extends radially.

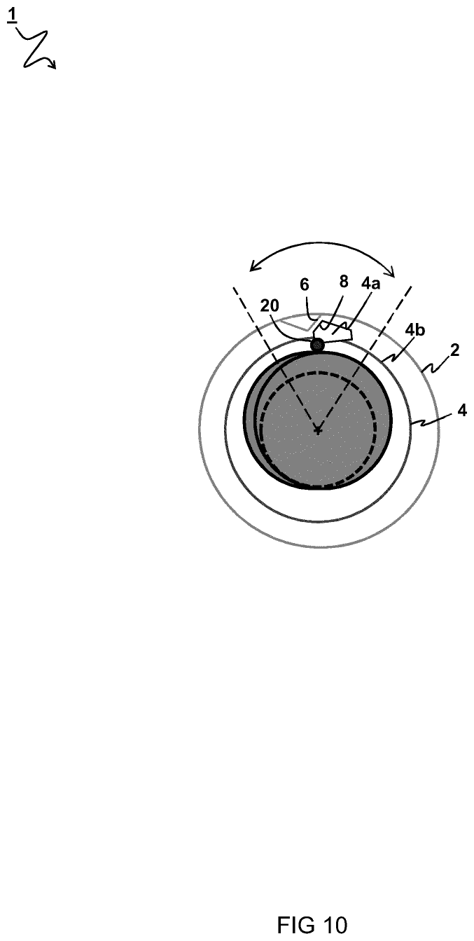

In the examples of FIGS. 1-9, the third clutch unit 10 is freely rotatable relative to the second clutch unit 4. There is no limit to the rotational displacement of the third clutch unit 10 relative to the second clutch unit 4. In this example there is only one gripping member 4a and only one retaining member 12, wherein there is a first position range, here a first angular position range in which the cam 10a is in the first position. Similarly, in this example, there is a second position range, here a second angular position range, in which the cam 10a is in the second position. FIG. 10 shows an example where the clutch system 1 is in the first position, for two angular end positions for the rotatable cam 10a. Here, when the rotatable cam 10a is in the first position range, the rotatable cam 10a is in the first position, locking the first and second abutment surface 6, 8 in engagement. Similarly, when the rotatable cam 10a is in the second position range, the rotatable cam 10a is in the second position, releasing the first and second abutment surface 6, 8 from each other. In these examples, the second angular range is larger than the first angular range.

The third clutch unit 10 can for example be rotated relative to the second clutch unit 4 from the first angular position range to the second angular position range and vice versa. in one and the same rotational direction.

A bearing 20 is arranged between the second clutch unit 4 and the third clutch unit 10, particularly between the gripping member 4a of the second clutch unit 4 and the retaining member 12 of the third clutch unit 10. Here the bearing is a rolling-contact bearing 20, but it will be appreciated that a sliding-contact bearing may additionally or alternatively be provided. The rolling-contact bearing 20 provides a rolling contact, e.g. instead of a sliding contact, between the gripping member 4a and the retaining member 12, in particular when the retaining member 12 moves the gripping member radially inward and outward, thus facilitating the movement of the third clutch unit 10 relative to the second clutch unit 4 between the first position and the second position and reducing wear. When the retaining member 12 locks the gripping member 4a in engagement with the first clutch unit, the normal forces between the gripping member 4a and the retaining member 12 are proportional to the load exerted on the clutch system, e.g. by the rider. The normal forces and hence the friction forces associated therewith between the gripping member 4a and the retaining member 12 may be reduced by provision of the rolling-contact bearing 20.

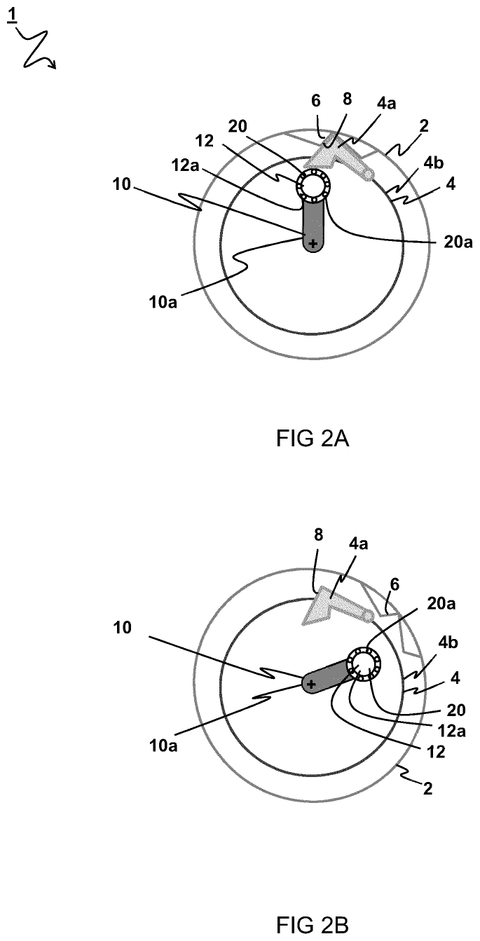

The rolling contact bearing 20 may include one or more rollers. In the example of FIGS. 1A and 1B, a roller 20a that is associated with, here rotatably mounted to, the gripping member 4a. The roller 20a may hence be seen as part of the gripping member 4a. The roller 20a is rollingly engaged by the retaining member 12 when the third clutch unit 10 is moved to the first position so as to push the gripping member 4a to a radial outer position for engaging the first clutch unit 2. When the third clutch unit 10 is moved to the second position, the retaining member 12 rollingly engages the roller 20a for enabling the gripping member 4a to be released from the first clutch unit 2 and return to the radially inward position. It will be appreciated that the roller 20a need not necessarily engage the third clutch unit 10 in the second position. In the example of FIGS. 2A and 2B, the roller 20a is associated with, here rotatably mounted to, the third clutch unit 10.

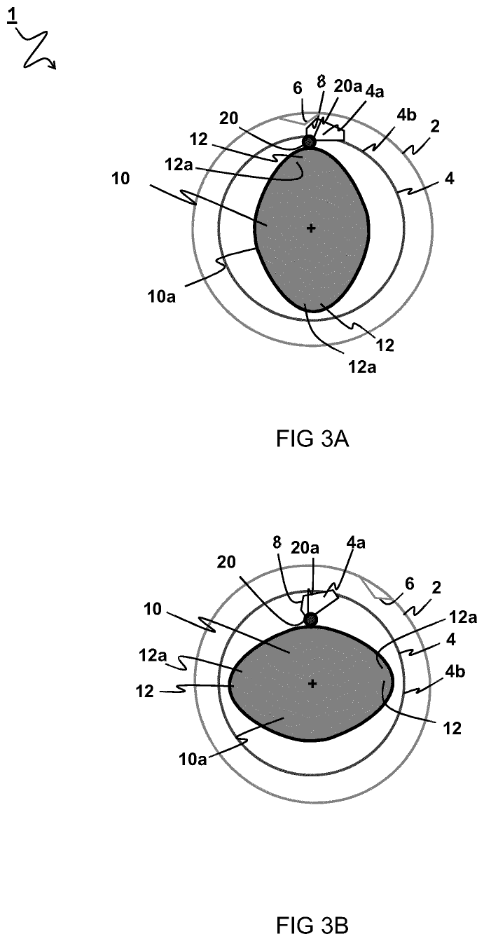

FIGS. 1A-9B show examples where the third clutch unit 10 is formed as a cam 10a. The retaining member 12 of the third clutch unit 10 is formed as a lobe 12a of the cam 10a in these examples. In the examples of FIGS. 1A-9B, the cam 10a includes a single lobe 12a, but it will be appreciated that the cam 10a may include multiple lobes, such as two lobes, three lobes, four lobes, five lobes or more. In the examples of FIGS. 1A-3B, the cam 10a has non-circular cross section. In FIGS. 1A and 1B, the lobe 12a has a section with a large radius, e.g. a substantially straight section, here for being in engagement with the roller 20a. In FIGS. 2A and 2B, the lobe 12a is formed by the rolling-contact bearing 20. In FIG. 3 the cam 10a has a convex-shaped cross section, here substantially egg-shaped and has a continuous smooth engagement surface for engaging the gripping member.

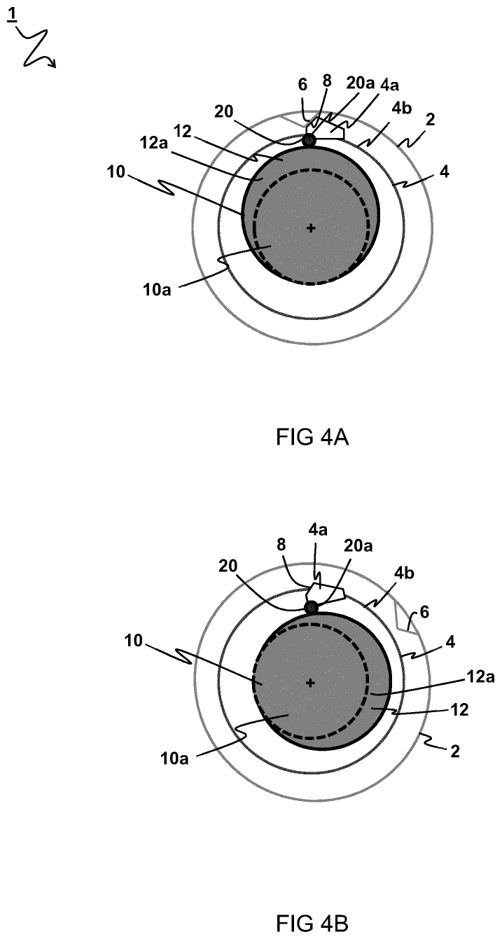

In the examples of FIGS. 4-9, the cam 10a has a circular cross section. The lobe 12a of a circular cam 10a may be considered as crescent-shaped with respect to a circular base of the cam la which is indicated by a dashed line. The circular cam 10a is coaxially and eccentrically positioned relative to the second clutch unit 4.

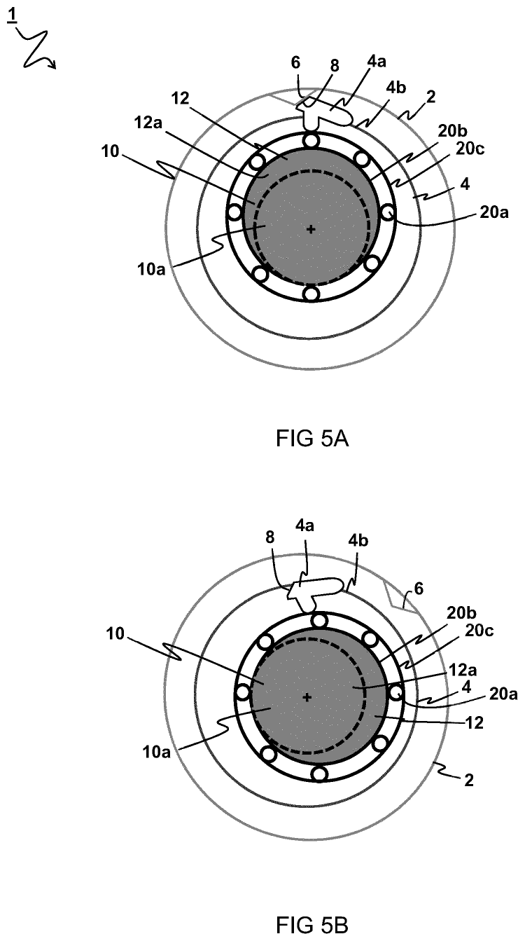

FIG. 5 shows an example where the rolling-contact bearing 20 comprises two concentric bearing races, particularly in inner race 20b and an outer race 20c, surrounding the circular cam 10a. Rollers 20a are arranged between the two bearing races 20b, 20c in this example. The inner race 20b is fixed to the cam 10a. The outer race 20c is arranged for engaging the gripping member 4a.

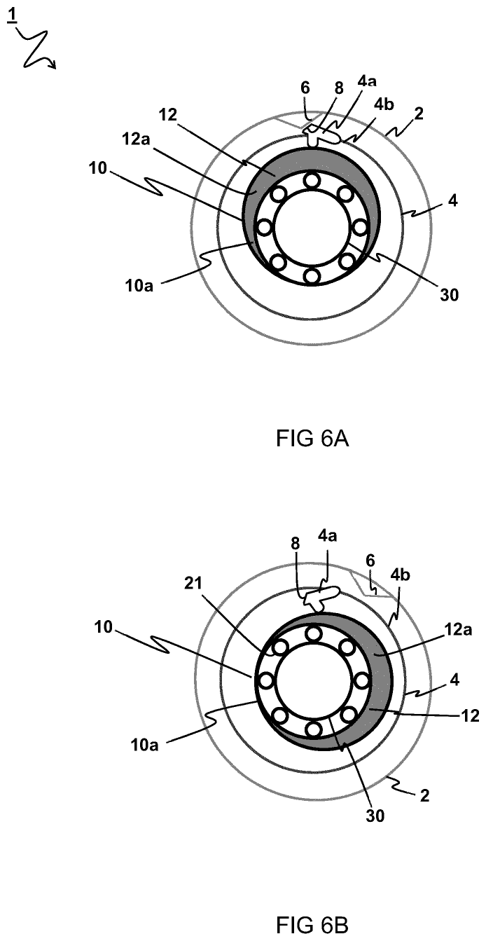

FIG. 6 shows an example where the cam 10a is bearing mounted to an axle 30, by a further bearing 21. In the example of FIG. 6, the clutch system 1 does not include a rolling-contact bearing between the gripping member 4a and the retaining member 12. The axle 30 may be stationary, e.g. non-rotatably coupled to a frame of the bicycle. Alternatively, the axle 30 may rotatable, e.g. co-rotatable with the second clutch unit 4. In a particular example, the second clutch unit 4 is stationary, e.g. relative to frame of the bicycle. The second clutch unit 4 may for example non-rotatably mounted to, or integrated with, the stationary axle 30. Hence, the second clutch unit may be stationary.

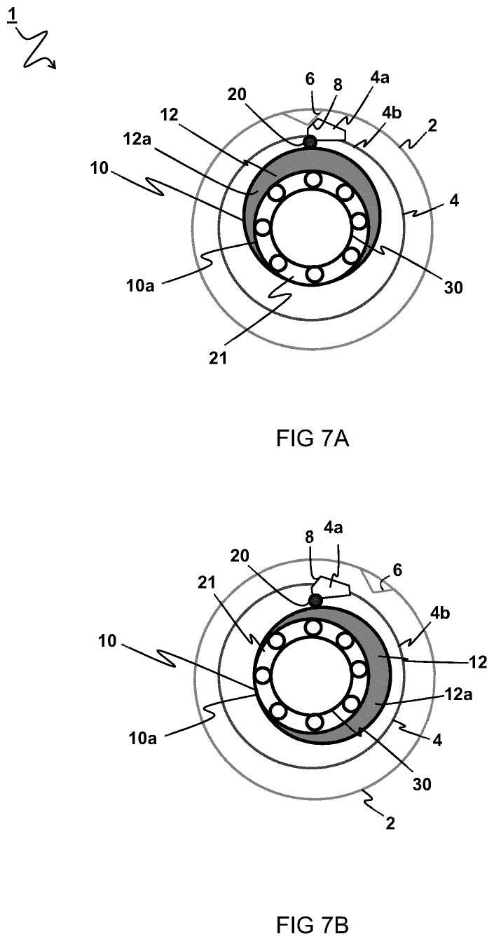

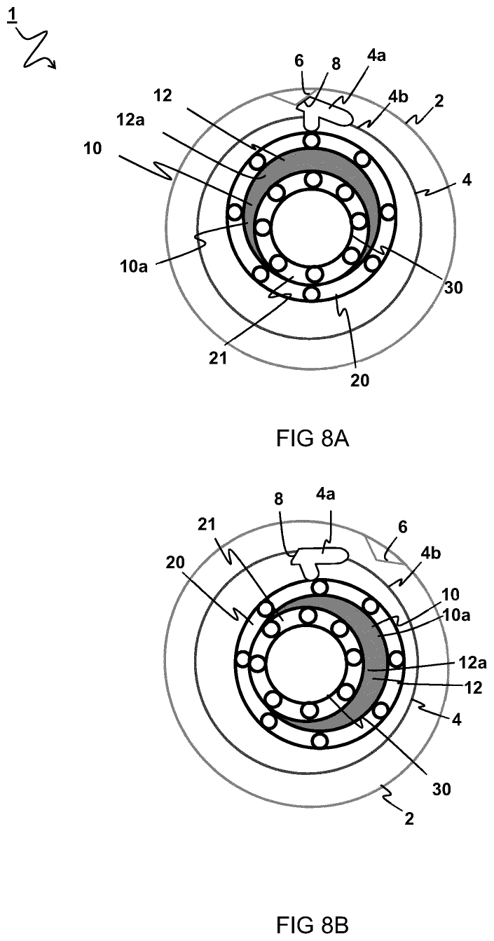

FIGS. 7 and 8 show examples where the cam 10a is bearing mounted to an axle 30, and wherein a rolling-contact bearing 20 is arranged between the cam 10 and the gripping member 4a.

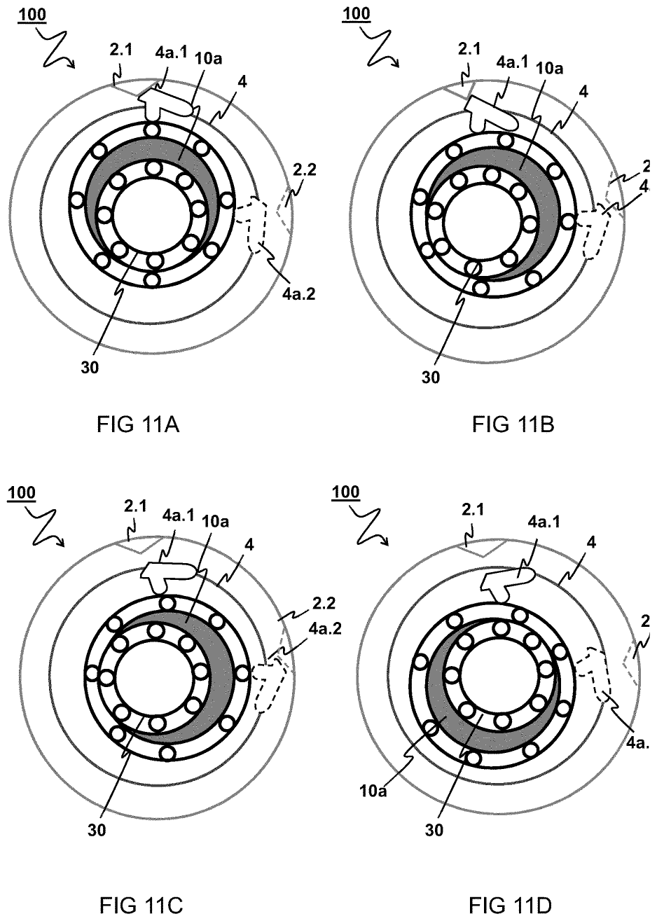

FIG. 11A-11D show an example of a clutch assembly 100, comprising a first clutch system 1 and a second clutch system 1. The third clutch units 4 of the first and second clutch systems are rotatably coupled to each other. In this example, the cams 10a of the first and second clutch systems 1 are integrated into a single cam shaft 10a. Here the integrated cam shaft 10a is bearing mounted to an axle 30, which axle 30 may be stationary. The integrated cam shaft 10a has a circular cross section in this example. The integrated cam shaft 10a is eccentrically arranged relative second clutch units 4 of the first and second clutch systems 1. The second clutch units 4 of the first and second clutch systems are also integrated in this example, wherein the respective gripping members 4a.1, 4a.2 are angularly staggered with respect to each other. Here, each second clutch unit 4 includes only one gripping member 4a.1, 4a.2 wherein the gripping member 4a.2 of the second clutch unit of the second clutch system 1 is angularly spaced from the gripping member 4a.1 of the second clutch unit 4 of the first clutch system 1. The angular staggering is in this example about 90 degrees. Here, the gripping member 4a.2 of the second clutch unit 4 of the second clutch system 1 is also axially spaced from the gripping member 4a.1 of the second clutch unit 4 of the first clutch system 1. The gripping member 4a.2 of the second clutch system 1 is indicated in FIG. 11 with a dashed line. The first clutch unit 2.1 of the first clutch system 1 and the first clutch unit 2.2 of the second clutch unit are rotatable relative to each other. Each first clutch unit 2.1, 2.2 includes a respective first abutment surface.

FIG. 11A shows a first state of the clutch assembly 100 in which the first clutch system 1 is engaged while the second clutch system 1 is disengaged. FIG. 11C shows a second state of the clutch assembly 100 in which the first clutch system 1 is disengaged while the second clutch system 1 is engaged. FIG. 11B shows a third state of the clutch assembly 1000 in which both the first clutch system 1 and the second clutch system 1 are engaged. FIG. 11D shows a fourth state of the clutch assembly in which both the first clutch system 1 and the second clutch system 1 are disengaged. The clutch assembly 100 is movable between the first, second, third and fourth states by rotation of the eccentrically arranged integrated cam shaft 10a about the axle 30. In this example, a 90 degree clockwise rotation of the integrated cam shaft 10a moves the clutch assembly 100 from the first state to the third state. The rotation of the integrated cam shaft 10a from the first state to the second state is via the third state in this example. This way the second clutch system 1 is allowed to engage prior to the disengagement of the first clutch system. Conversely, when the integrated cam shaft 10a is rotated to move from the second state to the first state via the third state, the first clutch system 1 is allowed to engage prior to the disengagement of the second clutch system 1.

The integrated cam shaft 10a may hence be used to selectively clutch one of the first clutch units 2 of the first and second clutch systems 1 to the integrated second clutch unit 4.

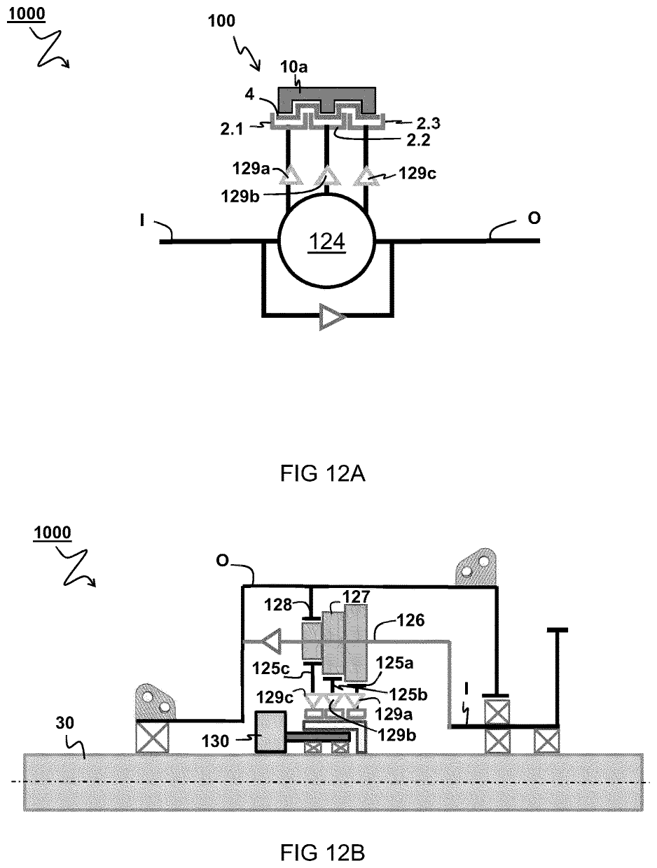

FIG. 12A shows a schematic example of a bicycle transmission 1000. FIG. 12B shows a hub assembly comprising the bicycle transmission 1000. The bicycle transmission 1000 includes an input I and an output O. The bicycle transmission 1000 includes a gear transmission, here a planetary transmission 124. The planetary transmission 124 in this example comprises a three sun gears 125a 125b, 125c, a planet carrier 126 carrying a stepped planet gear 127, and a ring gear 128. The input I is, here, associated with the planet carrier 126. The stepped planet gear 127 in this example includes three radii for respectively cooperating with the three sun gears 125a, 125b, 125c. The ring gear 128 cooperates with the stepped planet gear 127 at one of the three different radii.

The bicycle transmission 1000 includes a clutch assembly 100 as described in view of FIG. 11A-11D. Here the clutch assembly 100 includes three clutch systems 1 as described in view of FIGS. 1-10. The integrated second clutch unit 4 is non-rotatably mounted to the stationary axle 30. The integrated cam shaft 10a is rotatably drivable relative to the integrated second clutch unit 4 about the stationary axle 30 by an electric actuator 130. The first clutch units 2.1, 2.2, 2.3 of the respective clutch systems 1 are rotatable relative to one another about the axle 30. Each first clutch unit 2.1, 2.2, 2.3 is associated with a respective one of the three sun gears 125a, 125b, 125c, here coupled via respective freewheel 129a, 129b, 129c. Each first clutch unit 2.1, 2.2, 2.3, is selectively couplable to the integrated second clutch unit 4, by rotatingly driving the integrated cam shaft 10a. Hence, each sun gear 125a, 125b, 125c is selectively clutchable to the stationary axle 30 via the clutch assembly 100, by driving the integrated cam shaft 10a in rotation about the stationary axle 30 by a single electric actuator 130.

The exemplary bicycle transmission 1000 is operable according to four different transmission ratios, here a unitary transmission ratio and three speed-increasing transmission ratios. The unitary transmission ratio is obtained by having the sun gears 125a, 125b, 125c unclutched from the axle 30. Each speed-increasing transmission ratio is obtained by having a respective one of the two sun gears 125a, 125b, 125c clutched to the axle 30.

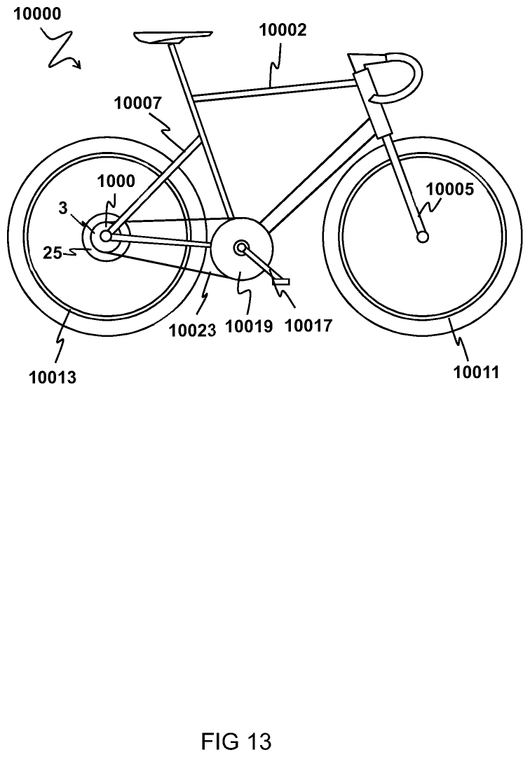

FIG. 13 shows a bicycle 10000. The bicycle 10000 comprises a frame 10002 with a front fork 10005 and a rear fork 10007, as well as a front wheel and a rear wheel 10011, 10013 located in the front and rear fork respectively. The bicycle 10000 further comprises a crank 10017, and a front chain wheel 10019. The comprises a transmission system 1000, in this example embodied as a hub transmission. The bicycle 10000 also comprises a sprocket 3, wherein a chain 10023 threads over the front chain wheel 10019 and the sprocket 3.

Herein, the invention is described with reference to specific examples of embodiments of the invention. It will, however, be evident that various modifications and changes may be made therein, without departing from the essence of the invention. For the purpose of clarity and a concise description features are described herein as part of the same or separate examples or embodiments, however, alternative embodiments having combinations of all or some of the features described in these separate embodiments are also envisaged.

In the examples, the first clutch unit includes one first abutment surfaces. It will be appreciated that the first clutch unit may include more than one abutment surface. In the examples, the second clutch unit includes one second abutment surface. It will be appreciated that other numbers of second abutment surfaces, such as two, three, four, five, six or any other suitable number are also possible. In most examples, the third clutch unit includes one retaining members. It will be appreciated that other numbers of retaining members, such as two, three, four, five, six or any other suitable number are also possible. In the example of FIGS. 3A and 3B, the third clutch unit comprises two retaining members, formed by two respective lobes 12a of a single cam 10a, on opposing sides.

In the examples, the gripping members are separate items hingedly connected to a body portion of the second clutch unit. It will be appreciated that it is also possible that the gripping members are integral with the body portion of the second clutch unit.

In the examples, the gripping members are arranged for pivoting in a radial direction. It will be appreciated that it is also possible that the gripping members are arranged for pivoting in an axial direction. Then e.g. the second clutch unit and the first clutch unit can be positioned, at least partially, axially next to each other. Also, then the third clutch unit and the second clutch unit can be positions, at least partially, axially next to each other.

In the examples, the first clutch unit, the second clutch unit and the third clutch unit are coaxially arranged, with the second clutch unit being arranged between the first clutch unit and the third clutch unit, the first clutch unit being inner an outermost clutch unit and the third clutch unit being the innermost clutch unit. It will however be appreciated that other arrangements are also envisioned. For example, the first clutch unit may be arranged within the second clutch unit, and the second clutch unit may be arranged within the third clutch unit.

Herein, the invention is described with reference to specific examples of embodiments of the invention. It will, however, be evident that various modifications, variations, alternatives and changes may be made therein, without departing from the essence of the invention. For the purpose of clarity and a concise description features are described herein as part of the same or separate embodiments, however, alternative embodiments having combinations of all or some of the features described in these separate embodiments are also envisaged and understood to fall within the framework of the invention as outlined by the claims. The specifications, figures and examples are, accordingly, to be regarded in an illustrative sense rather than in a restrictive sense. The invention is intended to embrace all alternatives, modifications and variations which fall within the spirit and scope of the appended claims. Further, many of the elements that are described are functional entities that may be implemented as discrete or distributed components or in conjunction with other components, in any suitable combination and location.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A clutch system for a bicycle transmission having an input and an output, the clutch system including:
a first clutch unit connectable to the input or output, including a first abutment surface;
a second clutch unit connectable to the output or input, including a gripping member having a second abutment surface arranged for selectively engaging the first abutment surface, the first and second abutment surfaces being adapted to each other so as to allow disengaging under load;
a third clutch unit including a retaining member, the third clutch unit being arranged for selectively being in a first position or a second position relative to the second clutch unit, wherein the retaining member in the first position locks the second abutment surface in engagement with the first abutment surface for rotationally coupling the second clutch unit to the first clutch unit, and in the second position releases the second abutment surface for disengagement of the first abutment surface for decoupling the second clutch unit from the first clutch unit; and
a bearing between the retaining member and the gripping member.

2. The clutch system of claim 1, wherein the bearing is a rolling-contact bearing or sliding-contact bearing.

3. The clutch system of claim 1, including an actuator, particularly an electrically controlled actuator, for rotating the third clutch unit and/or the second clutch unit from the first position to the second position, and/or from the second position to the first position.

4. The clutch system of claim 3, wherein the actuator is triggerable from outside the clutch system, such as via a (wireless) control unit.

5. The clutch system of claim 1, wherein in the first position, the retaining member is substantially radially aligned with the gripping member for retaining the second abutment surface in an engagement position for engaging the first abutment surface, and wherein in the second position, the retaining member is radially unaligned with the gripping member for releasing the second abutment surface from the engagement position.

6. The clutch system of claim 2, wherein the rolling-contact bearing includes a roller which is rotatably mounted to the gripping member for being in rolling-contact with the retaining member, or wherein the rolling-contact bearing includes a roller which is rotatably mounted to the retaining member for being in rolling-contact with the gripping member.

7.-9. (canceled)

10. The clutch system of claim 1, wherein the third clutch unit comprises a rotatable cam, and wherein the retaining member is formed by a lobe of the rotatable cam.

11. The clutch system of claim 10, wherein a cross section of the rotatable cam has a convex shape.

12.-21. (canceled)

22. The clutch system of claim 1, wherein the gripping member comprises a first gripping member part having the second abutment surface and a second gripping member part hingedly connected to the first gripping member part and arranged for being in bearing-contact with the retaining member.

23. The clutch system of claim 10, wherein the rotatable cam is bearing mounted to an axle.

24.-25. (canceled)

26. The clutch system of claim 23, wherein the axle is arranged for co-rotating with the second clutch unit, and/or wherein the axle is non-rotatably fixed to a stationary part, such a bicycle frame or housing, and/or wherein the second clutch unit is non-rotatably fixed to a stationary part, such as a bicycle frame or housing.

27. The clutch system of claim 1, wherein the second clutch unit comprises at most one gripping member.

28. The clutch system of claim 1, wherein the third clutch unit comprises at most one retaining member.

29. The clutch system of claim 1, wherein the gripping member of the second clutch unit is hingedly connected to a remainder of the second clutch unit, and wherein the gripping member is furthermore translatable relative to the remainder of the second clutch unit along a predefined translation path.

30. The clutch system of claim 29, wherein the gripping member is resiliently translatable relative to the remainder of the second clutch unit along the predefined translation path.

31.-34. (canceled)

35. The clutch system of claim 1, wherein the second and third clutch units are biased relative to each other towards a stable relative position.

36. The clutch system of claim 1, wherein the engagement or disengagement of the second abutment surface with the at least one first abutment surface is substantially independent of input torque and/or rotation speed.

37. The clutch system of preceding claim 1, wherein the first and/or second abutment surface is biased to disengage.

38. A clutch system for a bicycle transmission having an input and an output, the clutch system including:
a first clutch unit connectable to the input or output, including a first abutment surface;
a second clutch unit connectable to the output or input, including a gripping member having a second abutment surface arranged for selectively engaging the first abutment surface, the first and second abutment surfaces being adapted to each other so as to allow disengaging under load;
a third clutch unit including a retaining member, the third clutch unit being arranged for selectively being in a first position or a second position relative to the second clutch unit, wherein the retaining member in the first position locks the second abutment surface in engagement with the first abutment surface for rotationally coupling the second clutch unit to the first clutch unit, and in the second position releases the second abutment surface for disengagement of the first abutment surface for decoupling the second clutch unit from the first clutch unit; and
wherein a rolling-contact is provided between the retaining member and the gripping member.

39.-57. (canceled)

58. A bicycle transmission system, including the clutch system of claim 1, and a transmission selectively operable according to one of a plurality of transmission ratios, wherein the clutch system is arranged in the bicycle transmission system so as to selectively shift the transmission from one transmission ratio to another and/or vice versa.

59.-74. (canceled)
